(19) United States
(12) Patent Application Publication
(10) Pub. No.: US 2015/0059737 A1
(43) Pub. Date: Mar. 5, 2015

(54) RETAINING RING FOR MOUTHPIECES ATTACHED TO DIVING APPARATUS

(71) Applicant: American Underwater Products, Inc., San Leandro, CA (US)

(72) Inventors: Zachary Alexander Hollis, Castro Valley, CA (US); Michael John Gunning, Battle Ground, WA (US); Philippe Frasca, Marseille (FR)

(73) Assignee: American Underwater Products, Inc., San Leandro, CA (US)

(21) Appl. No.: 14/013,282

(22) Filed: Aug. 29, 2013

(51) Int. Cl. B63C 11/18; B63C 11/20; A62B 9/04; B63C 11/22

(52) U.S. Cl. CPC B63C 11/186; B63C 11/2227; B63C 11/205; A62B 9/04
USPC 128/201.11; 128/202.27

(57) ABSTRACT

Retaining rings for use with mouthpieces utilized in underwater diving in accordance with embodiments of the invention are described. One embodiment of the invention includes a mouthpiece configured to engage with a diving apparatus including a first end configured to be worn in the mouth of a diver, a second end configured to engage with a diving apparatus, and a retaining ring movably disposed between the first end and the second end from a first position to a second position, wherein when the retaining ring is in the first position the mouthpiece is removably attached to the diving apparatus, and wherein movably disposing the retaining ring to the second position securely attaches the mouthpiece to the diving apparatus.

### FIELD OF INVENTION

The present invention is generally related to mouthpieces utilized in underwater diving and specifically to reusable retainers for use in conjunction with mouthpieces.

### BACKGROUND OF THE INVENTION

Skin divers and swimmers use the snorkel as a means to breathe while swimming face down on the water surface. The snorkel functions as a conduit between the diver's mouth and the overhead air. Typically, the open end of the snorkel conduit extends a short distance above the water surface while the closed end of the snorkel conduit terminates in a mouthpiece. The mouthpiece is adapted to be held in the mouth of the diver and provides a flow path between the conduit and the interior of the diver's mouth.

The development of self-contained breathing systems has enabled humans to dive and remain underwater for several hours. Scuba tanks generally utilize a pressurized source of breathable gas, such as compressed air as well as mixed gas blends, having pressures in the range of 3,000 to 5000 psi. A two stage pressure reduction system is typically used to deliver the gas to a scuba diver at a pressure that is within an appropriate pressure range for underwater diving. A first stage regulator reduces the pressure of gas from the scuba tank to an intermediate pressure range of about 120 to 140 psi, while a second stage regulator, typically incorporated into a breathing mask, regulates the flow of gas delivered to the diver to a pressure that depends on the depth of the diver in the water. A mouthpiece connected to the second stage regulator and/or breathing mask provides a means for the diver to inhale and exhale the breathable gas while performing underwater dives.

### SUMMARY OF THE INVENTION

Retaining rings for use with mouthpieces utilized in underwater diving in accordance with embodiments of the invention are described. One embodiment of the invention includes a mouthpiece configured to connect to a diving apparatus includes a first end configured to be worn in the mouth of a diver, a second end including an coupling channel and configured to engage with a diving apparatus, and a retaining ring, including a coupling ridge and movably disposed between the first end and the second end from a first position to a second position, wherein when the retaining ring is in the first position the mouthpiece is removably attached to the diving apparatus, wherein when the retaining ring is in the second position the coupling ridge cooperatively engages with the coupling channel, and wherein movably disposing the retaining ring to the second position securely attaches the mouthpiece to the diving apparatus by applying pressure to the mouthpiece and the diving apparatus.

Yet another embodiment of the invention includes a mouthpiece configured to engage with a diving apparatus including a first end configured to be worn in the mouth of a diver, a second end configured to engage with a diving apparatus, and a retaining ring movably disposed between the first end and the second end from a first position to a second position, wherein when the retaining ring is in the first position the mouthpiece is removably attached to the diving apparatus, and wherein movably disposing the retaining ring to the second position securely attaches the mouthpiece to the diving apparatus.

In another embodiment of the invention, the diving apparatus is a second stage regulator.

In an additional embodiment of the invention, the diving apparatus is a snorkel.

In yet another additional embodiment of the invention, the retaining ring is configured to apply pressure to the mouthpiece and the diving apparatus in the second position.

In still another additional embodiment of the invention, the retaining ring is configured to engage the diving apparatus in the second position.

In yet still another additional embodiment of the invention, the diving apparatus includes a coupling end, and the second end of the mouthpiece is configured to engage with the coupling end of the diving apparatus.

In yet another embodiment of the invention, the coupling end of the diving apparatus includes an attachment ridge, the second end of the mouthpiece includes an attachment channel, and wherein the attachment channel and attachment ridge cooperatively couple to removably attach the mouthpiece to the diving apparatus.

Still another embodiments of the invention includes a retaining ring including an outer portion and an inner portion, wherein the inner portion of the retaining ring is configured to engage with an outer portion of a mouthpiece having a first end configured to be worn in the mouth of a diver and a second end configured to engage with a diving apparatus, wherein the retaining ring is movably disposed along the mouthpiece between the first end and the second end from a first position to a second position, and wherein moving the retaining ring from the first position to the second position applies pressure to the mouthpiece.

In still another embodiment of the invention, the inner portion includes a coupling ridge configured to cooperatively engage with a coupling channel on the mouthpiece.

In yet still another embodiment of the invention, the inner portion includes a coupling channel configured to cooperatively engage with a coupling ridge on the mouthpiece.

In yet another additional embodiment of the invention, the retaining ring further includes a locking member configured to engage with a diving apparatus.

In still another additional embodiment of the invention, the locking member is located on the outer portion of the retaining ring.

In yet still another additional embodiment of the invention, the locking member is located on the inner portion of the retaining ring.

In yet another embodiment of the invention, the mouthpiece engages with the diving apparatus and the locking member engages with the diving apparatus when the locking member is in the second position.

In still another embodiment of the invention, the mouthpiece engages with a diving apparatus and the retaining ring applies pressure to the mouthpiece and the diving apparatus securely attaching the mouthpiece to the diving apparatus.

In yet still another embodiment of the invention, the retaining ring is constructed using plastics.

In yet another additional embodiment of the invention, the retaining ring is constructed using a metal selected from the group consisting of titanium and stainless steel.

In still another additional embodiment of the invention, the retaining ring is constructed using rubber.

### BRIEF DESCRIPTION OF THE DRAWINGS

FIG. 1 is a conceptual illustration of a mouthpiece with a retaining ring in accordance with an embodiment of the invention.

FIG. 2A is a conceptual illustration of a cross-section of a mouthpiece with a retaining ring engaged in a first position with a diving apparatus in accordance with an embodiment of the invention.

FIG. 2B is a conceptual illustration of a cross-section of a mouthpiece with a retaining ring engaged in a second position with a diving apparatus in accordance with an embodiment of the invention.

FIG. 3A is a conceptual illustration of a top view of cutaway of a mouthpiece with a retaining ring engaged with a diving apparatus in accordance with an embodiment of the invention.

FIG. 3B is a conceptual illustration of a bottom view of cutaway of a mouthpiece with a retaining ring engaged with a diving apparatus in accordance with an embodiment of the invention.

FIG. 4A is a conceptual illustration of a retainer ring having a coupling ridge with an embodiment of the invention.

FIG. 4B is a conceptual illustration of a retainer ring having a coupling channel in accordance with an embodiment of the invention.

### DETAILED DESCRIPTION OF THE INVENTION

Turning now to the drawings, retaining rings for use with mouthpieces utilized in underwater diving in accordance with embodiments of the invention are illustrated. Divers commonly use diving apparatus to breathe underwater, allowing the diver to spend more time underwater and/or dive to deeper depths. A variety of diving apparatus can be utilized by divers as appropriate to the requirements of specific applications in accordance with embodiments of the invention, including snorkels and self-contained breathing systems. In a variety of embodiments, a self-contained breathing system includes a second stage regulator that regulates the flow of gas delivered to the diver. A diving apparatus includes a mouthpiece that allows a diver to breathe through the diving apparatus. Mouthpieces are commonly affixed to a diving apparatus using a disposable securing means, such as a zip tie, a c-clip, or a hose clamp, that must be secured and removed from the mouthpiece on a regular basis. Significant damage can result to the mouthpiece and/or the diving apparatus if the disposable securing means is not fastened and/or removed properly. Additionally, the disposable nature of these securing means results in having to regularly replace the disposable securing means to ensure that the securing means does not fail during a dive. This also necessitates having a constant supply of replacement disposable securing means on hand in order to perform dives.

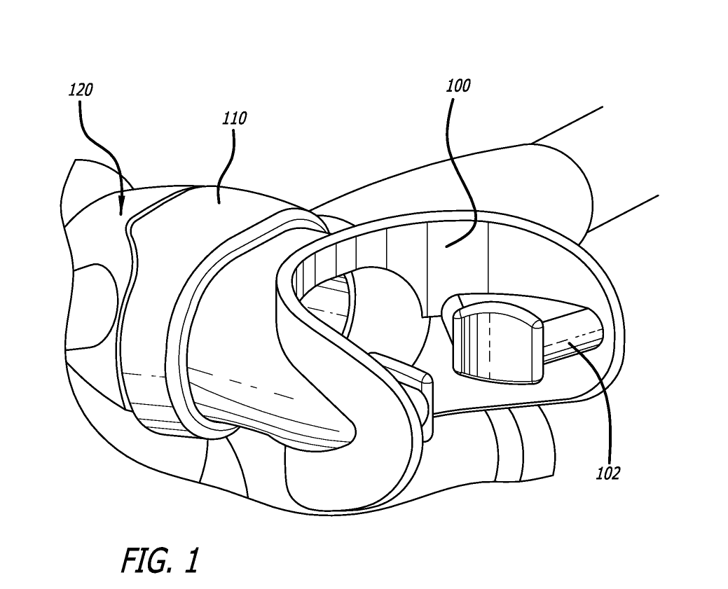

Retaining rings in accordance with embodiments of the invention are designed to reusably secure mouthpieces to diving apparatus. A conceptual illustration of a mouthpiece with a retaining ring in accordance with an embodiment of the invention is shown in FIG. 1. The mouthpiece 100 has a first end 102 configured to be worn in the mouth of the diver, allowing the diver to breathe through the diving apparatus 120. The mouthpiece 100 is securely attached to the diving apparatus 120 via the retaining ring 110. The retaining ring 110 includes a coupling member designed to engage with the mouthpiece 100 and/or the diving apparatus 120 to securely attach the mouthpiece 100 to the diving apparatus 120. The retaining ring can be constructed from any of a variety of materials as appropriate to the requirements of specific applications in accordance with embodiments of the invention. Materials commonly utilized include a variety of plastics (such as polyethylene, polypropylene, polystyrene, and polyvinyl chloride), rubber, and metals (including metal alloys) including stainless steel and titanium; other materials and combinations of materials suitable to use underwater can be utilized.

A variety of retaining rings can be utilized as appropriate to the requirements of specific applications in accordance with embodiments of the invention. Retaining rings with coupling ridges and coupling channels in accordance with embodiments of the invention are described below.

Securing Mouthpieces with Retaining Rings

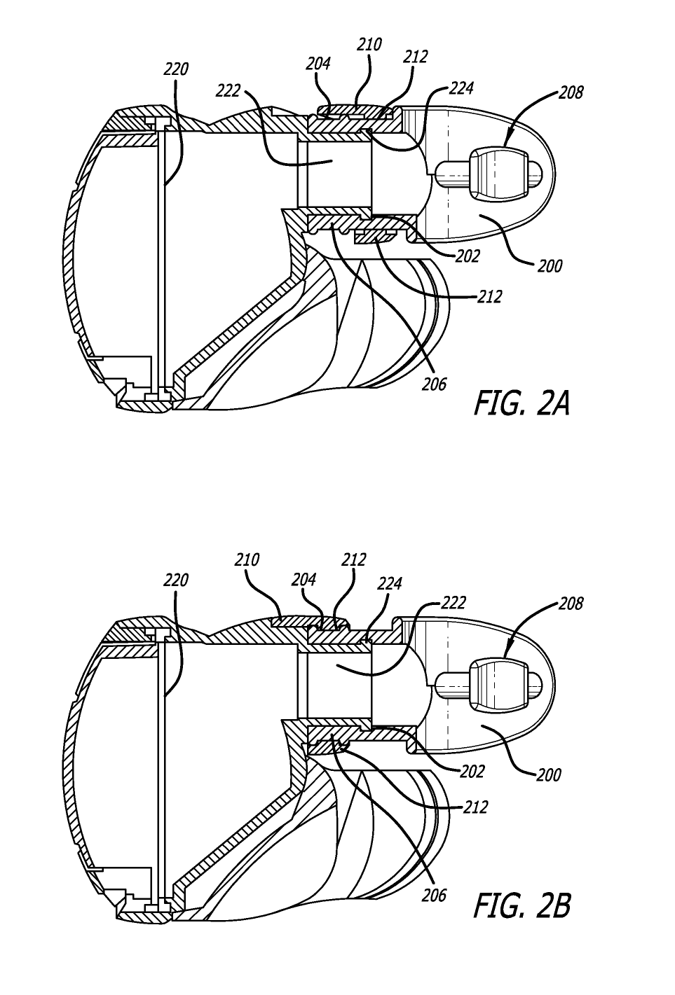

Turning now to FIG. 2A, a mouthpiece 200 is attached to a diving apparatus 220. The mouthpiece 200 includes a first end 208 configured to be worn in the mouth of a diver. The mouthpiece 200 also has a second end 206 engaged with the coupling end 222 of the diving apparatus 220. The coupling end 222 includes an attachment ridge 224. The second end 206 of mouthpiece 200 includes an attachment channel 202. When the mouthpiece 200 is engaged with the diving apparatus 220, the attachment ridge 224 cooperatively couples with the attachment channel 202, removably securing the mouthpiece 200 to the diving apparatus 220.

The retaining ring 210 is located between the first end 208 and the second end 206 of the mouthpiece 200. In FIG. 2A, the retaining ring 210 is in a first position where the retaining ridge 212 on the inner portion of the retaining ring 210 is not engaged with the coupling channel 204 on mouthpiece 200. While in the first position, the retaining ring 210 is removably attached the mouthpiece 200 to the diving apparatus 220. A variety of techniques can be utilized as appropriate to the requirements of specific applications in accordance with embodiments of the invention to movably dispose the retaining ring 210 from the first position to a second position. These techniques include, but are not limited to, sliding the retaining ring from the first position to the second position along the mouthpiece 200.

Turning now to FIG. 2B, the retaining ring 210 has been movably disposed to a second position. In movably disposing the retaining ring 210 to the second position, the retaining ridge 212 cooperatively engages with the coupling channel 204, securely attaching the mouthpiece 200 to the diving apparatus 220. In a variety of embodiments, the retaining ring 210 applies pressure to the second end 206 of the mouthpiece 200 and/or the coupling end 222 of the diving apparatus 220 to securely attach the mouthpiece 200 to the diving apparatus 220. In several embodiments, the applied pressure compresses the mouthpiece 200 into the coupling end 222 of the diving apparatus 220.

Although the retaining ring conceptually illustrated in FIGS. 2A and 2B is configured to slide between the first position and the second position, it should be appreciated that any form of movement, including those retaining rings configured to rotate around the mouthpiece from a first position to a second position, can be utilized as appropriate to the requirements of specific applications in accordance with embodiments of the invention. Retaining rings with coupling channels and retaining rings with locking members in accordance with embodiments of the invention are described below.

Securing Mouthpieces with Retaining Rings with Coupling Channels

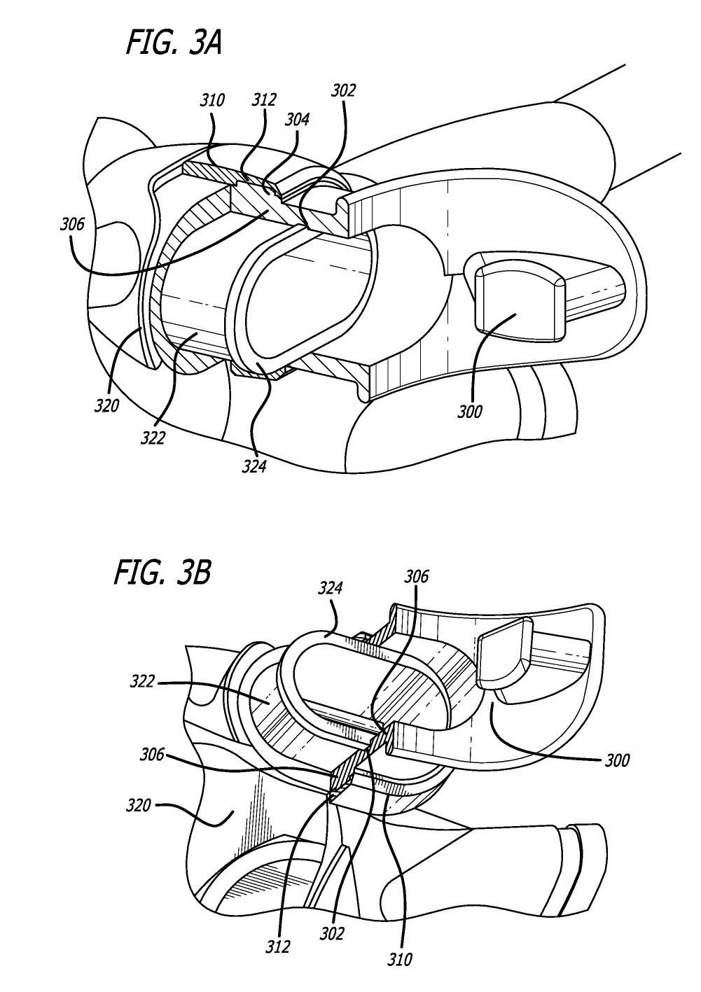

Turning now to FIG. 3A, a top view of a retaining ring 310 engaged in a second position with a mouthpiece 300 securely attached to a diving apparatus 320 is conceptually illustrated. The second end 306 of mouthpiece 300 is engaged with the coupling end 322 of diving apparatus 320. In several embodiments, the coupling end 322 includes an attachment ridge 324 configured to cooperatively engage with the attachment channel 302 within the second end of the mouthpiece 300, removably securing the mouthpiece 300 to the diving apparatus 320. The mouthpiece 300 further includes a coupling ridge 304 configured to cooperatively engage with a coupling channel 312 in the inner portion of the retaining ring 310 when the retaining ring 310 has been movably disposed to the second position. In a number of embodiments, the retaining ring 310 applies pressure to the second end 306 of the mouthpiece 300 and/or the coupling end 322 of the diving apparatus 320 to securely attach the mouthpiece 300 to the diving apparatus 320.

Turning now to FIG. 3B, a bottom view of the retaining ring engaged in a second position with a mouthpiece and a diving apparatus is conceptually illustrated. While in FIG. 3A and 3B the coupling ridge 304 and coupling channel 312 encircling the entire retaining ring 310 and mouthpiece 300, it should be noted that a portion of the coupling ridge 304 can be contained on the retaining ring 310 and/or a portion of the coupling channel 312 can be contained on the second end 306 of the mouthpiece 300 as appropriate to the requirements of specific applications in accordance with embodiments of the invention. Similarly, the attachment ridge 324 can be partially (or fully) contained within the second end 306 of the mouthpiece 300, while the corresponding attachment channel 302 can be partially (or fully) contained within the coupling end 322 of the diving apparatus 320 as appropriate to the requirements of specific applications in accordance with embodiments of the invention. In a variety of embodiments, the coupling ridge 304 and/or the coupling channel 312 can be contained on the coupling end 322 of the diving apparatus 320. In this way, the retaining ring 310 engages with the diving apparatus 320 to securely attach the mouthpiece 300 to the diving apparatus 320 as the retaining ring 310 is movably disposed from the first position to the second position. In many embodiments, the engagement of the retaining ring 310 to the coupling end 322 blocks the second end 306 of the mouthpiece 300 from being removed from the coupling end 322. In a variety of embodiments, the retaining ring 310 blocks the second end 306 of the mouthpiece 300 from being removed from the coupling end 322 by physically obstructing the movement of the second end 306, thereby physically preventing the mouthpiece 300 from being removed from the coupling end 322.

Retaining rings that utilize coupling channels to securely affix a mouthpiece to a diving apparatus in accordance with embodiments of the invention are described above with respect to FIGS. 3A and 3B. However, it should be noted that retaining rings that both apply pressure and utilize blocking techniques to securely attach the mouthpiece to the diving apparatus could be utilized as appropriate to the requirements of specific applications in accordance with embodiments of the invention. Retaining rings with locking apparatus in accordance with embodiments of the invention are described below.

### Locking Retaining Rings

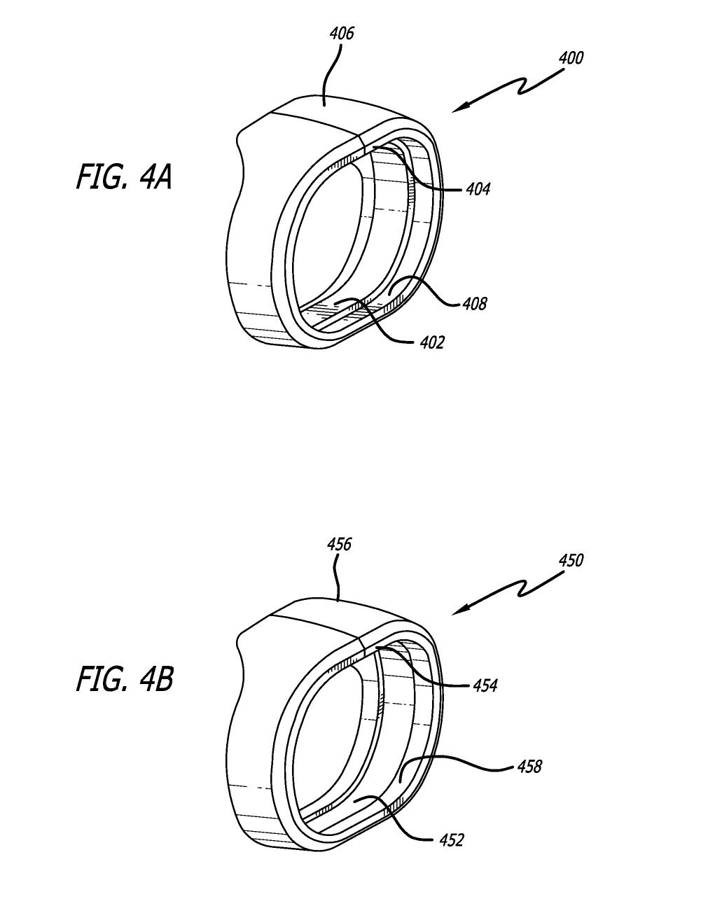

Turning now to FIG. 4A, a retaining ring having a locking member is conceptually illustrated. The retaining ring 400 includes an outer portion 404 and an inner portion having a coupling ridge 402 located on the inner portion 408 of the retaining ring 400. The internal coupling ridge 402 is designed to cooperatively couple with a coupling channel on a mouthpiece to securely attach the mouthpiece to a diving apparatus as the retaining ring 400 is movably disposed from a first position to a second position along the mouthpiece. In several embodiments, the retaining ring 400 further includes a locking member 406 designed to engage with a diving apparatus. When the locking member 406 is engaged with the diving apparatus, the retaining ring 400 is securely attached to the diving apparatus until the locking member is disengaged from the diving apparatus. Disengaging the locking member from the diving apparatus can be performed in a variety of ways as appropriate to the requirements of specific applications in accordance with embodiments of the invention, such as by pressing a disengagement button or physically disengaging the locking member. The locking member provides additional support for the secure attachment of the mouthpiece to the diving apparatus by the retaining ring in the second position and/or helps prevent the accidental disposition of the retaining ring from the second position to the first position while the mouthpiece and/or diving apparatus is being utilized by a diver. In this way, the locking member 406 provides support to maintain the secure attachment of the mouthpiece to the diving apparatus by limiting the ability of the retaining ring to be movably disposed to the first position while the locking member 406 is engaged with the diving apparatus. The locking member can be located on the outer portion 404, the inner portion 408, and/or in between the outer potion 404 and the inner portion 408.

Turning now to FIG. 4B, a retaining ring 450 includes an outer portion 454 and an inner potion 458 including a coupling channel 452. The coupling channel 452 is designed to cooperatively couple with a coupling ridge on a mouthpiece to securely attach the mouthpiece to a diving apparatus as the retaining ring 450 is movably disposed from a first position to a second position along the mouthpiece. In several embodiments, the retaining ring 400 further includes a locking member 406 designed to engage with a diving apparatus. When the locking member 456 is engaged with the diving apparatus, the retaining ring 450 is securely attached to the diving apparatus until the locking member is disengaged from the diving apparatus similar to the locking mechanism described above. It should be appreciated that a retaining ring can include a combination of coupling channels and coupling ridges as appropriate to the requirements of specific applications in accordance with embodiments of the invention. For example, a retaining ring can include multiple coupling ridges and/or coupling channels. Additionally, a retaining ring can include a coupling member that includes both ridges and channels, either in parallel, similar to having multiple coupling ridges and coupling channels, and/or in series, giving a coupling means that can be indexed and/or interlocked in a particular position with a mouthpiece and/or a diving apparatus.

Specific retaining rings are described above with respect to FIGS. 4A and 4B; however, it should be appreciated that a retaining ring can engage with a mouthpiece and/or a diving apparatus utilizing pressure and/or blocking techniques to securely attach the mouthpiece to the diving apparatus as appropriate to the requirements of specific applications in accordance with embodiments of the invention.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A mouthpiece configured to connect to a diving apparatus, comprising:
a first end configured to be worn in the mouth of a diver;
a second end comprising an coupling channel and configured to engage with a diving apparatus; and
a retaining ring, comprising a coupling ridge and movably disposed between the first end and the second end from a first position to a second position;
wherein when the retaining ring is in the first position the mouthpiece is removably attached to the diving apparatus;
wherein when the retaining ring is in the second position the coupling ridge cooperatively engages with the coupling channel; and
wherein movably disposing the retaining ring to the second position securely attaches the mouthpiece to the diving apparatus by applying pressure to the mouthpiece and the diving apparatus.

2. A mouthpiece configured to engage with a diving apparatus, comprising:
a first end configured to be worn in the mouth of a diver;
a second end configured to engage with a diving apparatus; and
a retaining ring movably disposed between the first end and the second end from a first position to a second position;
wherein when the retaining ring is in the first position the mouthpiece is removably attached to the diving apparatus; and
wherein movably disposing the retaining ring to the second position securely attaches the mouthpiece to the diving apparatus.

3. The mouthpiece of claim 2, wherein the diving apparatus is a second stage regulator.

4. The mouthpiece of claim 2, wherein the diving apparatus is a snorkel.

5. The mouthpiece of claim 2, wherein the retaining ring is configured to apply pressure to the mouthpiece and the diving apparatus in the second position.

6. The mouthpiece of claim 2, wherein the retaining ring is configured to engage the diving apparatus in the second position.

7. The mouthpiece of claim 2, wherein:
the diving apparatus comprises a coupling end; and
the second end of the mouthpiece is configured to engage with the coupling end of the diving apparatus.

8. The mouthpiece of claim 7, wherein:
the coupling end of the diving apparatus comprises an attachment ridge;
the second end of the mouthpiece comprises an attachment channel; and
wherein the attachment channel and attachment ridge cooperatively couple to removably attach the mouthpiece to the diving apparatus.

9. A retaining ring, comprising:
an outer portion; and
an inner portion;
wherein the inner portion of the retaining ring is configured to engage with an outer portion of a mouthpiece having a first end configured to be worn in the mouth of a diver and a second end configured to engage with a diving apparatus;
wherein the retaining ring is movably disposed along the mouthpiece between the first end and the second end from a first position to a second position; and
wherein moving the retaining ring from the first position to the second position applies pressure to the mouthpiece.

10. The retaining ring of claim 9, wherein the inner portion comprises a coupling ridge configured to cooperatively engage with a coupling channel on the mouthpiece.

11. The retaining ring of claim 9, wherein the inner portion comprises a coupling channel configured to cooperatively engage with a coupling ridge on the mouthpiece.

12. The retaining ring of claim 9, further comprising a locking member configured to engage with a diving apparatus.

13. The retaining ring of claim 12, wherein the locking member is located on the outer portion of the retaining ring.

14. The retaining ring of claim 12, wherein the locking member is located on the inner portion of the retaining ring.

15. The retaining ring of claim 12, wherein:
the mouthpiece engages with the diving apparatus; and
the locking member engages with the diving apparatus when the locking member is in the second position.

16. The retaining ring of claim 9, wherein:
the mouthpiece engages with a diving apparatus; and
the retaining ring applies pressure to the mouthpiece and the diving apparatus securely attaching the mouthpiece to the diving apparatus.

17. The retaining ring of claim 9, wherein the retaining ring is constructed using plastics.

18. The retaining ring of claim 9, wherein the retaining ring is constructed using a metal selected from the group consisting of titanium and stainless steel.

19. The retaining ring of claim 9, wherein the retaining ring is constructed using rubber.
